(19) United States
(12) Patent Application Publication
(10) Pub. No.: US 2017/0292308 A1
(43) Pub. Date: Oct. 12, 2017

(54) Control System for Self Restoring Doors, Gates and Windows

(71) Applicant: Mark A. Beran, Niwot, CO (US)

(72) Inventor: Mark A. Beran, Niwot, CO (US)

(21) Appl. No.: 15/097,147

(22) Filed: Apr. 12, 2016

(51) Int. Cl. E05F 3/20; E05F 1/10; E05F 15/72

(52) U.S. Cl. CPC E05F 3/20; E05F 15/72; E05F 1/1033; E06B 5/16

(57) ABSTRACT

This invention teaches a motion control system for self-closing or self-opening pivot hung doors, gates and windows being disposed within a hollow chamber of a pivot hung door, gate or window connected to the door surrounding structure only at the door pivots. The system stores elastic strain energy as the door is displaced from its nominal position and controllably releases that energy to self restore the system to its nominal position. The system consists of serially connected torsion means and dampening means wherein torsion means includes a torsion bar and a torque modulator, and dampening means includes a housing and a rotor operatively rotational in housing.

### CROSS-REFERENCE TO RELATED APPLICATIONS

This application claims priority of Provisional U.S. Patent Application 62/230,133 under 35 U.S.C. Section 119(e).

Pat. No. 5,572,768 P, Daul teaches a rotary friction damper in a device, external to the door, such as a hinge, for connecting a door to an adjacent structure, including a helical spring operatively connected to the door and the structure.

Pat. No. 5,787,549 P, Soderlund, is a hinge system for attaching a hinged element to a base forming a hinged unit. The hinge system included first and second torsion rods fixed directly to the hinged element and to the base.

Pat. No. 7,195,300, Austin, teaches an automotive tailgate hinge assembly that counterbalances the weight of the tailgate storing energy in a torsion bar connected at one end to the tailgate and at the other end directly connected to the frame of the automobile.

Pat. No. 7,219,391 B1, Luca, teaches a door assembly and a door closer arranged and constructed so as to be wholly concealed within the associated door. The apparatus consists of a standard piston or rack and pinion style door closer disposed within the upper or lower hollow door rail and an arm connected at one end to the piston of the door closer. The arm protrudes through the pivot side door edge to receive a mounting bracket attached to the door jamb.

Pat. No. 8,732,094 B2, Busch, teaches a cam based hydraulic door closer with a helical spring for energy storage. Busch delineates non-linear torque vs door angular displacement relationships that are typical for door closer applications.

### BACKGROUND OF INVENTION

This invention relates to the field of commercial, industrial and residential swing doors, gates and windows that rotate about a pivot axis. The invention is applicable to pivot hung doors that are displaced in one direction and subsequently self restore to their nominal or at rest positions, being driven by spring potential energy stored during the displacement of the door from its nominal position. It is also applicable to special security or fire doors that serve as a means of egress and can move rapidly, without external power, from nominal, spring energized position to a second, displaced position, upon receipt of an external stimulus such as a fire alarm, emergency signal, or the activation of a panic device.

The current invention overcomes inherent limitations of the existing art for self-closing doors that, including those that rely on surface mounted door closers that are operatively engaged by means of external connecting arms, slide tracks, or both. The complete concealment of the control system of the current invention offers benefits of cost, safety, security, ease of installation and improved aesthetics over the existing art. Some of the primary limitations of the prior art are exemplified in the following referenced citations.

Pat. No. 5,572,768 P, Daul, teaches a helical spring and friction device contained in a door hinge. This invention is limited in the magnitude of the torque that can be transferred to the door. Also, the angular displacement at the spring is identical to that of the door and this relationship cannot be altered. The use of this invention for pivot mounted doors is not taught.

Pat. No. 5,787,549 P, Soderlund teaches the use of a torsion bar in the hinge to replace the helical spring taught by Daul and is also not applicable to pivot mounted doors.

Pat. No. 7,219,391 B1, Luca, relies on the offset of the door hinge with respect to the vertical middle plane of the door as a moment arm to cooperate with a piston force and thereby produce a torque on the door. This invention relies on a mechanical connection between the door closer within the door, and the door jamb, and is not applicable to pivot hung doors. There are many examples in the prior art in which door closers are disposed within the door. All of these require an operative connection to the structure around the door.

Pat. No. 8,732,094 B2, Busch discloses torque vs. displacement curves that are typical for surface mounted door closers. These curves reveal that the desired torque on the door decreases in a non-linear fashion as the door opens. This contrasts the approximately linearly increasing torque vs door angular displacement that would be inherent if a spring, whether helical or torsion, were connected directly between the door and a fixed reference.

Pat. No. 7,195,300, Austin, teaches a counterbalanced tailgate mechanism with a torsion bar mounted between the tailgate at one end and the fixed frame of the automobile at the other end. This system does not provide for a non-linear relationship between the angular displacement of the tailgate and the twist angle of the torsion bar. The fixed relationship between the torsion bar windup and tailgate position limits the quality of the counterbalancing effect of the torsion bar, since perfect balancing of the tailgate would require a sinusoidal increasing torque on the tailgate as it moves from the latched position to the open position.

As is evident from the cited art, mechanical systems to facilitate the self closing of swing doors are well known. Absent, however, in the prior art, is a system disposed within a self restoring pivot hung door; connected, or in contact with, the surrounding structure around the door only at the pivots; providing non-linear modulation of stored torque and selective energy dissipation.

### BRIEF SUMMARY OF THE INVENTION

The control system of this invention overcomes the cited limitations of the prior art by means of the serial disposition of a new and novel torsion means and rotary dampener. Elongated torsion means, such as torsion bars, disposed within a door, benefiting from the volume of the hollow chamber in the door and not just from the cross sectional area thereof, can deliver large torques at acceptable working stress levels. The invention makes use of torsion bars disposed in door stiles and rails operatively engaged with the door to impart, on the door, a torque that is decreasing in a non-linear fashion as the door is displaced from its nominal position. Furthermore, the invention employs a new and novel rotary dampening device disposed within the door and operatively engaged with said torsion means to provide energy dissipation to control the restorative angular velocity of the door.

The invention teaches the apparatus and method of field adjusting the restorative torque on the door in its nominal position using the door as a convenient lever to manually energize the torsion bar to an initialized torque, or angle of twist.

The control system of this invention provides new and novel improvements over the existing art with the following benefits:

said control system is entirely concealed within the door and does not require connections to the structure around the door other than at the pivots,

said control system provides increased efficiency by reducing the complexity of the operative hardware between the energy storage component and the door.

said control system eliminates the ubiquitous rack and pinion drive of existing self contained door closers,

said control system provides for easy installation and initialization of the torque on the door in its nominal position,

said control system provides enhanced safety by the elimination of finger pinch points inherent in hinge and pivot mounted doors.

said control system provides enhanced security since the hardware, installed within the door, is tamperproof, and

said control system can be manufactured to meet the most stringent domestic and foreign guidelines for door safety such as ANSI A156.4.

It is an object of this invention to teach a new and novel door control system that is disposed within a hollow cross section of a door that provides all the functionality of an ANSI A156.4 Grade 1 door closer without the necessity of an operative connection, or arm, that is connected between the structure around the door and the door closer.

It is an object of this invention to teach a new and novel method of energizing a self restoring door by use of a torsion bar disposed within the door itself.

It is an object of this invention to teach a control system for controlling the motion of a self restoring pivot hung door when said door includes a panel, such as a solid glass plate, and a hollow pivot side stile in which the control system is disposed.

It is an object of this invention to teach a control system for controlling the motion of a self restoring pivot hung door when said door is a hollow door such as the hollow metal doors used in many commercial applications, having at least a hollow pivot side stile and one hollow rail in which to dispose the control system.

It is an object of this invention to teach the means by which a torsion bar disposed within a door is indirectly coupled to the door so that the manual opening of the door results a resistive torque on the door that is either increasing, constant, or decreasing; either linearly or non-linearly.

It is an object of this invention to improve the efficiency of the existing door closer art by eliminating sliding friction losses including those inherent in the rack and pinion elements of the existing art.

It is an object of this invention to teach a new and novel rotary dampener or dashpot, disposed within the stiles and rails of a self restoring pivot hung door, consisting of a housing and a rotor, within the housing, to control the closing speed of the door.

It is an object of this invention to teach a self restoring pivot hung door which maintains a small, consistent gap between pivot side door stile and the pivot side door jamb throughout the allowable motion of the door, thereby eliminating pinch points that are a safety concern on existing doors.

The benefits of this invention are improved efficiency, aesthetics, safety, security, cost, and ease of installation compared to the prior door closer art.

### BRIEF DESCRIPTION OF THE SEVERAL VIEWS OF THE DRAWING

FIG. 1A—Top plan view of the door header indicating Section A-A.

FIG. 1B—Section view A-A of door and header. The door is shown in the closed position. The door pivots on the right side and the moving wing rotates out of the page as the door opens.

FIG. 1C—Detail view, A, of the torque modulator of this invention, disposed within the upper rail and the pivot side stile of the door.

FIG. 1D—Detail view, B shows the preferred location of the rotary dampener of this invention as well as the adjustable bottom pivot of this invention.

FIG. 1E—Enlarged perspective view of Detail A.

FIG. 2A—Front plan view of the alternate embodiment of the invention disposed within the hollow pivot side stile of the door. The pivot side door stile and corresponding pivot side door jamb are shown displaced to the right to reveal the apparatus of this invention.

FIG. 2B—Top plan view of the alternate embodiment with the door stile and door jamb displaced to the right of their actual position

FIG. 2C Detail view, C, of the torque modulator.

FIG. 2D—Detail D enlarged to illustrates the unique cross sections of the door stile and the mating door jamb.

FIG. 2E—Perspective view of Detail C showing the key components of the torque modulator operatively disposed between the fixed header, 10, above the door, and the rotating end of the torsion bar, 45.

FIG. 3A—Top view of the rotary viscous dampener of this invention, indicating Section B-B.

FIG. 3B—Section view B-B showing the rotor, 22, and housing, 21, of the rotary viscous dampener.

FIG. 3C—Section view C-C indicated in FIG. 3D illustrating the disposition of the rotor in the housing.

FIG. 3D—Side plan view of the rotary viscous dampener of this invention showing sweep and latch adjustment ports and Section C-C.

FIG. 3E—Perspective view of the rotary viscous dampener of this invention

FIG. 4A—Exploded view of the adjustable bottom pivot of this invention.

FIG. 4B—Side plan view of torsion lock plate, 26, of the adjustable bottom pivot

FIG. 4C—View D-D of the torsion lock plate, 26, of the adjustable bottom pivot

FIG. 5A—Depicts the restorative torque vs angle of displacement for the main embodiment of this invention.

FIG. 5B—Depicts the restorative torque vs angle of displacement for the alternate embodiment of this invention.

### LIST OF FIGURE REFERENCES

1 torsion bar
2 torque modulator
3 cam pulley
4 cable
5 crank link
6 coupler link
7 follower link
8 rotary dampener
9 bottom pivot
10 header
11 shaft
12 mounting bracket
13 cam pulley
14 crank shaft
15 latch port
16 sweep port
17 rotor
18 bearing
19 bearing
20 void
21 housing
22 shaft end
23 shaft end
24 elongated boss
25 check valve
26 locking torque plate
27 flat head screws
28 socket head screw
29 gap
30 socket head screw
31 thrust bearing
32 bearing, outer race
33 locking sleeve
34 central bore
35 door stile
36 torque converter
37 four bar linkage
38 chaises
39 shaft
40 door bearing
41 bracket
42 crank
43 coupler
44 follower
45 free end of torsion bar
46 coupling
47 door jamb
48 cable
49 cam pulley
50 cam pulley
51 control ports
52 region A
53 region B
54 sealing surfaces
55 o ring seal
56 alt torque modulator
57 door panel
58 door frame
59 right angle drive
60 torque transfer drive

### DETAILED DESCRIPTION OF THE INVENTION

For purposes of illustration, the nominal position of the door is assumed to be the closed position, however, the specification is not intended to be limited by this assumption. The structure of the invention includes a torsion means for storing and controllably releasing potential energy and a dampening means to dissipate, as waste heat, kinetic energy of a moving door. The torsion means consists of an elongated member capable of storing elastic strain energy in torsion, such as a torsion bar, and a torque modulator. The torque modulator defines the relationship between angular displacement of the door and the corresponding angular displacement of the torsion bar as the door oscillates between the limits of its motion. The torsion means is disposed in a hollow chamber within the pivot hung door.

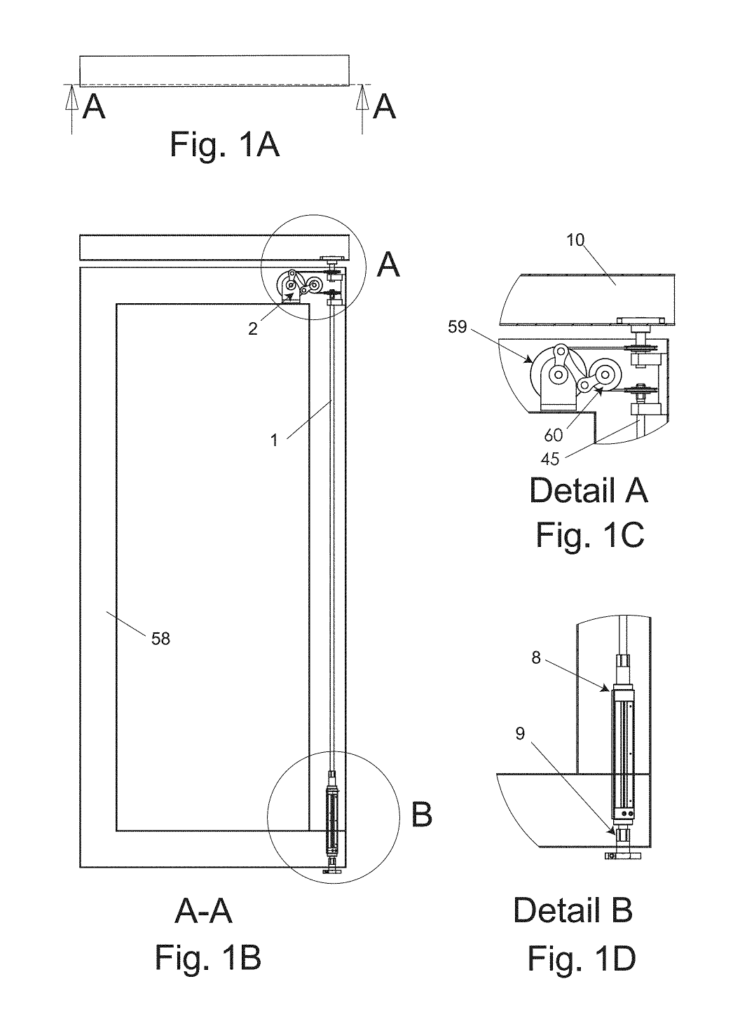

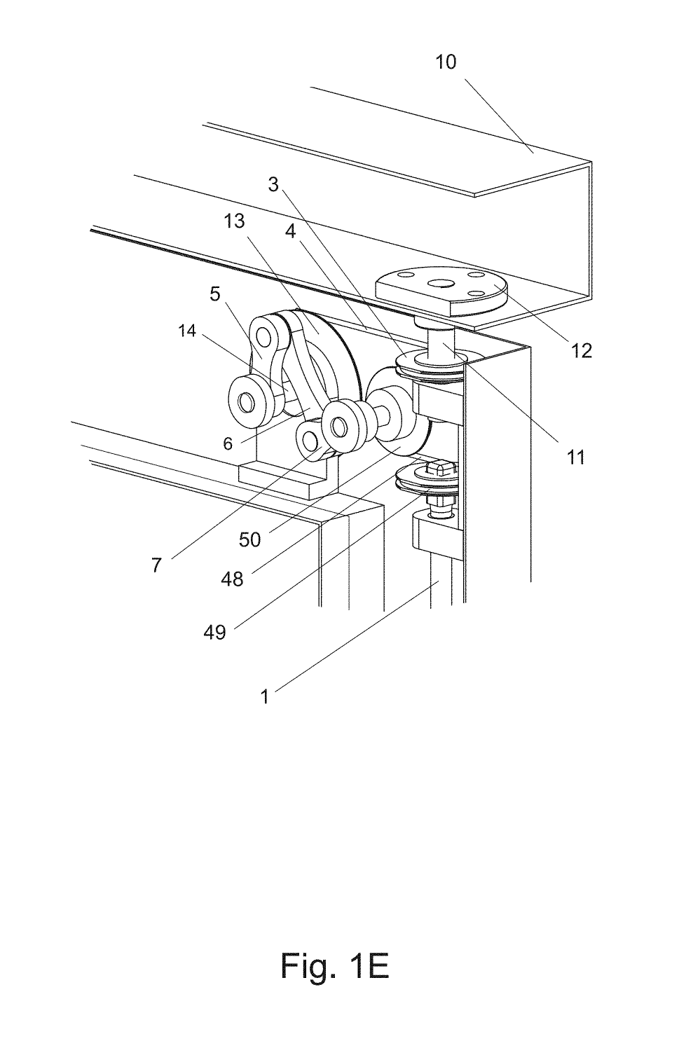

Referring to FIG. 1B, the torque modulator, 2, of the main embodiment includes a four bar linkage with moving links, 5, 6, and 7, shown in FIG. 1E. The pivot hung door is the fourth link and is fixed relative to the links 5, 6, and 7. It is well known to those skilled in the art of kinematic synthesis of linkages that any four bar linkage can be equivalently represented by a pair of cams in rolling contact. These cams, one fixed and one moving are derived from the fixed polode and moving polode of the four bar linkage, respectfully. Thus, the torque modulator linkage, embodied herein, could equally be embodied by an equivalent system consisting of two cams or two cam shaped pulleys fixedly connected by a cable, belt or chain so as to maintain their relative rolling contact kinematics. However, because of the high torques and bearing loads associated with the self restoring pivot hung door application, the linkage itself is the best known embodiment of this invention.

FIG. 1A shows a top view of the pivot hung door and indicates Section A-A. Referring to Section A-A in FIG. 1B, the energy storage is accomplished by means of a torsion bar, 1. The torsion bar of this invention consists of one or more elongated members suitable for storing elastic strain energy in torsion, disposed in a parallel arrangement an connected at each end with common end plates. Working in unison, multiple elongated members can, for a given length, provide the same torque as a single torsion bar while at the same time significantly reducing the maximum torsional stress in each individual elongated member with respect to that of a single torsion bar. The parallel arrangement of multiple torsion bars can optimize energy density while at the same time minimizing the working stresses of the torsion bars. In a practical example of a medium size swing door with a preload torque of 36 ft-lb, six torsion bars of diameter 0.176 inches working in parallel have a working shear stress 70% lower than that which would exist in a single torsion bar at the same torque and angular displacement, of diameter 0.55 inches, or 15 mm.

A novel feature of this invention is the concealed torque modulator, 2. Detail view A, FIG. 1C, shows the torque modular, 2 and its connection to the header, 10, or jamb above the pivot hung door by means of the right angle drive, 59, and its connection to the free end of torsion bar, 45, below it, by means of the transfer drive, 60. Referring now to FIG. 1E which shows a perspective view of the torsion means consisting of:

The right angle drive, 59, of this invention consisting of parts 3, 4, 11, 12, 13; torque modulator, 2, of this invention consisting of parts 5, 6, 7; torque transfer drive, 60, of this invention, consisting of parts 48, 49, 50; and torsion bar, 1.

The right angle drive, 59, provides the operative connection between the fixed header, 10, and the crank link, 5 of the torque modulator, and includes elements, 3 and 13 which may be circular or cam shaped and either concentrically or eccentrically mounted with respect their axes of rotation, hereinafter cam pulleys, and non endless cable, 4, fixedly attached at each end to one of cam pulleys 3, and 13. The operative profiles of said cam pulleys, whether circular, cam shaped, concentric or eccentric are determined by the specific requirements of the application under consideration. Said non endless cable, 4, may be constructed of rope, wire, belt or braided cable of material to suitable transfer torque from cam pulley to cam pulley. The torque modulator crank link, 5, is fixedly attached to cam pulley, 13, at proximal end by means of crank shaft, 14, and pivotably constrained to the door at said end. The distal end thereof is pivotably engaged with the proximal end of coupler link, 6. The distal end of coupler link, 6, is pivotably engaged with the proximal end of follower link, 7. The distal end of follower link, 7 rotates about a fixed point on the door and is fixedly attached to cam pulley, 50.

The torque transfer drive, 60, provides the operative connection between follower, 7 of the torque modulator, 2, and the free end of the torsion bar, 45, and consists of cam pulleys, 49, and 50, which may be circular with respect to their rotation axis or cam shaped, and non endless cable, 49, fixedly attached at each end to one of cam pulleys 49, and 50.

Selective removal of kinetic energy from during the restorative cycle of the pivot hung door is accomplished by the rotary dampener, 8, of this invention, shown in FIG. 1D. The adjustable bottom pivot of this invention, 9, also depicted in FIG. 1D, allows for ease of installation and setting of the torque on the door in its nominal position.

Referring to FIG. 1B, the pivot hung door, 58, is shown in the closed or nominal position. As the door opens the latch side edge of the door rotates out of the page as shown. It should be apparent to those skilled in the art that the locations of the torsion means, 2, shown in Detail A and the rotary dampener, 8, shown in Detail B of FIG. 1D, can be interchanged without altering the function thereof. Referring now to FIG. 1E, as the door wing rotates, cable, 4, winds up on non-rotating cam pulley, 3, which is fixedly attached to the header, 10, via shaft, 11, and mounting bracket, 12. Cam pulley, 13, begins to rotate. Cam pulley, 13, is fixedly attached to crank link, 5, which therefore rotates clockwise as viewed in the figure. Each unit of rotation of the crank, 5, results in a unique, non-constant rotation of the follower link, 7 whereby the relative displacement of the follower link, 7 is small at the beginning of the opening cycle and larger at the end of the opening cycle. Coupler link, 6, connects crank link, 5 and follower, 7, and moves in general coplanar motion as it rotates with respect to links 5 and 7. The four bar linkage, 5, 6, 7 serves to decrease the torque in torsion bar, 1, as the door opens, while the motion of the door itself tends to increase the torque of the torsion bar. The superposition of these motions, as the door opens, results in cable, 48, being taken up by cam pulley, 49, as it is released from cam pulley, 50. The resulting angular displacement at the torsion bar moving end, 45, is larger near the door closed position and smaller near the door open position. As the door moves between these two positions, the angular displacement relationship between the door and the torsion bar varies in a non-linear fashion with respect to a unit angular displacement of the door itself. As would be apparent to those skilled in the art, each of the cam pulleys described herein could be non-circular in design. This would allow further enhancement of the non-linear relationship between the door rotation and the torsion bar angular displacement. This is possible because the cables are not endless, they are fixedly attached to the cam pulleys, and because the relative angular displacement of the cam pulleys is a limited oscillation and not a continuous rotation. The non-circular cam pulleys would in this case act as cams capable of providing further non-linear enhancement between the door angular displacement and that of the torsion bar. When the door is released from its displaced position, the potential energy of the system, stored as elastic strain energy in the torsion bar is released in a prescribed fashion to deliver an appropriate torque on the door at each position during the restorative motion of the door.

A novel feature of this invention is rotary dampener, 8, which provides all of the energy dissipation capability and adjustability of the modern door closer and accomplishes this with a fixed housing element and a pivotably disposed element. The rotary dampener or dashpot, selectively dissipates excess energy during the closing cycle of the door and contains at least one field adjustable means to set the magnitude of the energy removed at a specific angle during the door closing cycle. The rotary dampener, shown in FIG. 1B, is disposed near the bottom of the door, mating with adjustable bottom pivot, 9, of this invention on the lower end of the dampener and to the torsion bar, 1, at the upper end of the dampener.

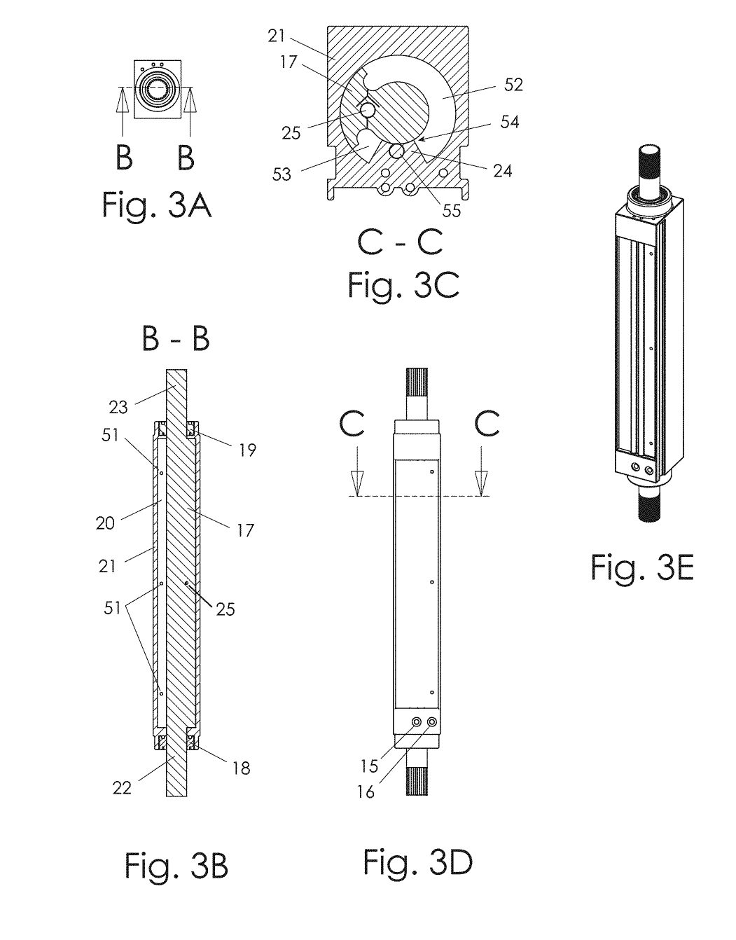

FIG. 3D is a plan view of the rotary dampener with latch port, 15, to control the speed of the door during the last approximately 15 degrees of door closing, and the sweep port, 16, to control the speed from the fully open position to approximately 15 degrees of opening. Section B-B is identified in FIG. 3A and shown in FIG. 3B. The elongated hatched area, 17, is a cross section view of the pivotably operative rotor, constrained by bearings, 18 and 19. Fluid, either pneumatic or hydraulic, in the void, 20, between the rotor, 17, and the housing, 21, is constrained within the housing by seals concentric with bearings, 18, and 19. Spring energized lip seals and o-rings seals are commonly used for this purpose. The void, 20, is defined by two regions, region A, 52, and region B, 53, as illustrated in FIG. 3C. Fluid is exchanged between the two regions via the check valve, 25, during door opening and via the ports, 51 and the latch valve, 15 and the sweep valve, 16, as the door closes. The indicated surfaces, 54 in Section view C-C, are in close proximity. Sealing between the two regions, A and B is accomplished by o-ring seal, 55, is indicated between the rotor, 17, and the boss, 24. Referring to FIG. 3C, the boss, 24, contains openings and pathways for the oil to travel past one or both of the latch and sweep valves as it travels from one side of the chamber defined by the rotor and boss to the other side of the chamber. The rotating rotor of the rotary dampener functions analogously to the sliding piston in the ubiquitous rack and pinion designs currently in use in the industry. The relative port locations and pathways are similar to those of the existing rack and pinion door closer art and are therefore not detailed herein. A check valve in the rotor, 25 allows the oil to bypass the latch and sweep pathways and instead flow directly from one chamber to the other for ease of manual door opening. The function of the rotary dampener mirrors that of the linearly constrained piston of common rack and pinion door closers. However, the dampening function facilitated for a door application in a device for which there is only relative rotation among the constituent parts is heretofore unknown in the art. The rotary dampener, offers efficiency benefits over the rack and pinion design because the rotary to linear motion conversion stage is eliminated. In addition, the rotary dampener, disposed within the door pivot stile and concentric with the central axis of rotation of the door further enhances efficiency, security, safety, reliability, cost and ease of door installation. As the door rotates, the rotary dampener housing rotates with the door, while the rotor is constrained by its connections to the bottom pivot and the torsion bar.

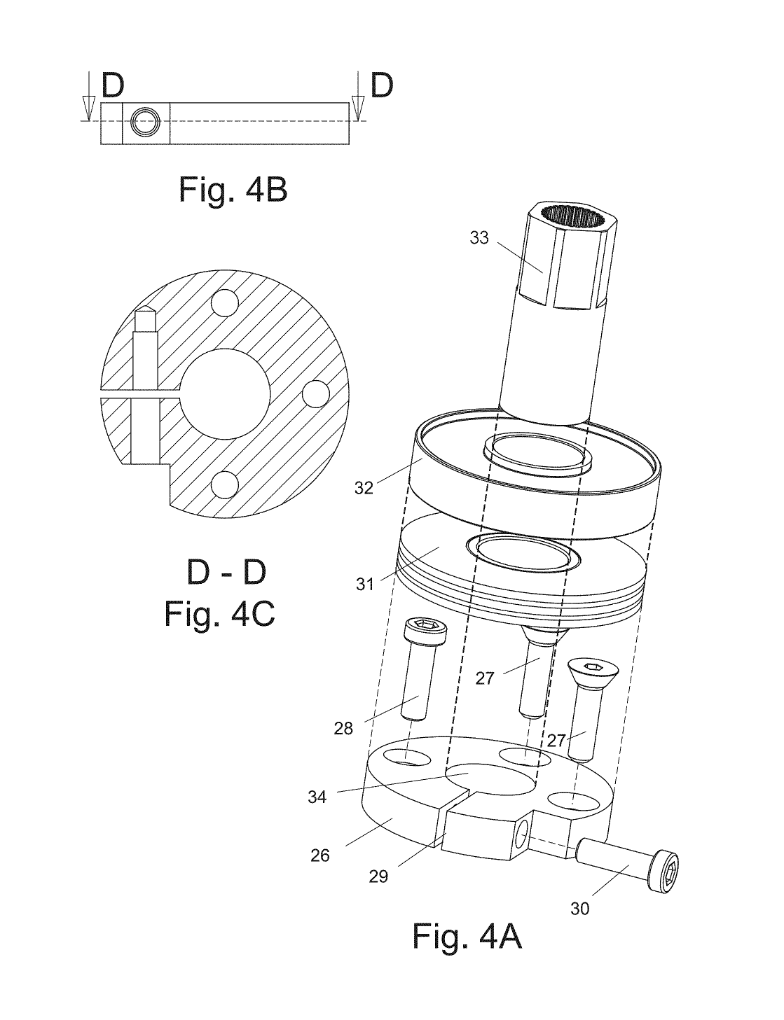

The adjustable bottom pivot of this invention, illustrated in FIG. 4A, 4B, and 4C, provides a very simple and safe means for commissioning the door with the proper torsion bar preload, i.e. the proper force of the door on the door surround, in its nominal position. Door pivots are commonly used in commercial and industrial swing doors. Those skilled in the art are familiar with the means of installation of a swing door between upper and lower pivots. Once the door is properly installed on its pivots it is necessary to set the torque of the door on the door surround. In commonly used, rack and pinion style door closers, this is accomplished with a tool used to set the initial displacement of a compression spring that pushes directly against the sliding piston of the closer. Since spring forces are very high it can be difficult and cumbersome for the installer to make significant changes to the factory setting of the compression spring. The adjustable bottom pivot of this invention makes this process very simple and safe because the door itself is used as a lever to set the initial displacement of the torsion bar. Given the large leverage that can be realized by pushing on the latch end of the door, even very large torques can be effortlessly set with the adjustable bottom pivot of this invention. Referring to FIG. 4A, an exploded view of the adjustable bottom pivot, the locking torque plate, 26, is securely fastened to the floor with screws, 27, preferably flat head screws, and screw, 28, preferably a socket head screw, engaged to allow subsequent compression of the gap, 29, facilitated by turning screw, 30, preferably a socket head screw. Thrust bearing and thrust washer assembly, 31, and roller bearing, 32, slide onto sleeve, 33, with preferably a close clearance fit. The sleeve inserts in the central bore, 34 of the locking torque plate, 26. The outer race of bearing, 32, mates with a bore in the door stile to define the axis of rotation of the door. With the adjustable bottom pivot in place, and the rotor pre-positioned in the rotary dampener housing to correspond to the nominal position of the door, the door is set in place and the screw, 30, is tightened to fix the rotor and prevent its rotation. The door is then opened to either a pre-specified position, or to a position for which the measured resistive torque on the door corresponds to the desired nominal door torque. The door is chocked in this position and a suitable retainer wrench is placed on the flats of sleeve, 33, to lock the torsion bar to the door. Access to the concealed hardware is easily accomplished by means of a small removable cover preferably located on the door edge nearest the door pivot. With the retainer in place, screw, 30, is loosened so that the sleeve, 33, now rotates with the door as it is manually returned to the nominal position. Screw, 30, is again tightened to secure the torsion bar to the bottom pivot. The retainer between the door and the torsion bar is then removed. The door is now ready for the final set up of the latch and sweep valves, accessible through said removable cover, to match the required closing times from fully displaced to approximately 15 degrees and from approximately 15 degrees to the nominal position, respectively.

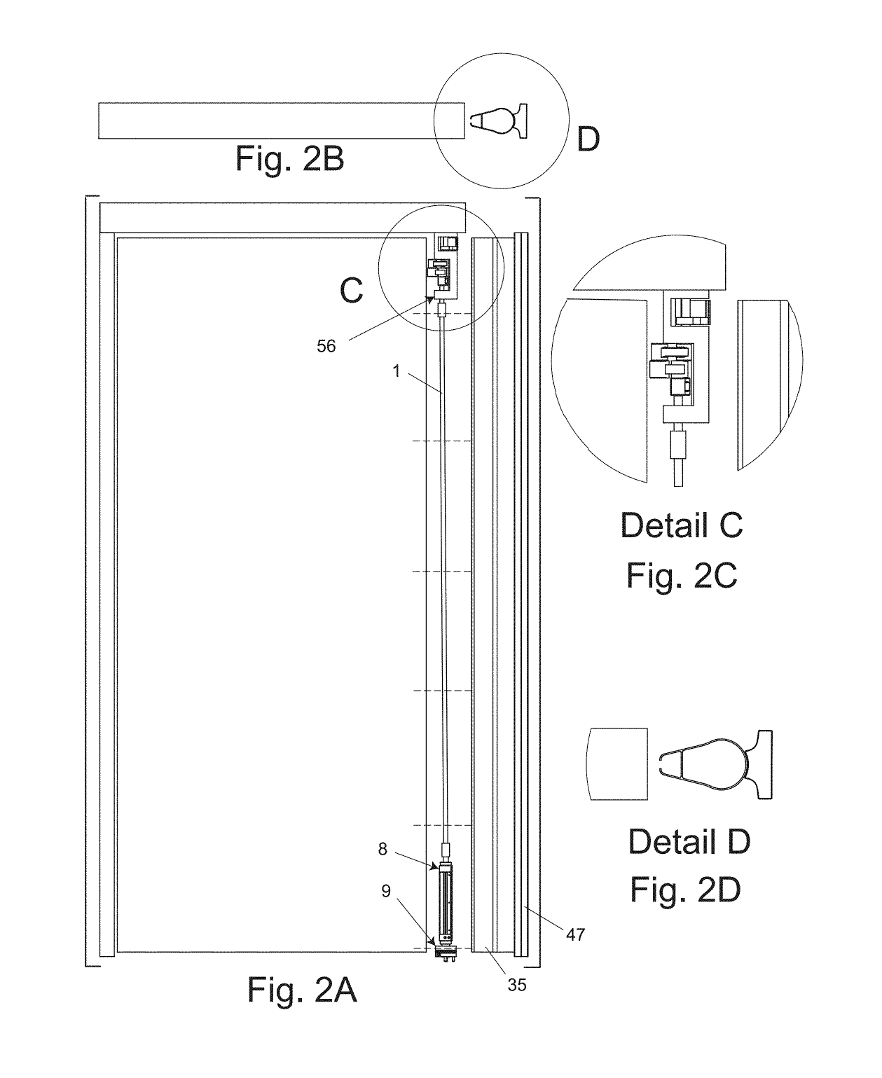

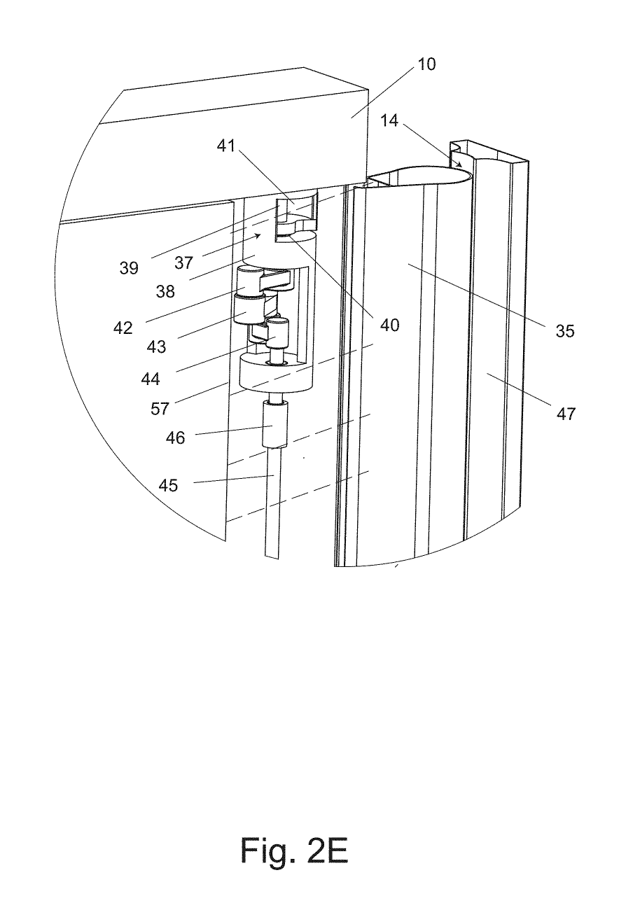

An alternate embodiment is illustrated in a partially exploded view in FIG. 2A, in which the vertical stile, 35, and door jamb, 47 have been displaced to the right in the illustrated figure to reveal the apparatus of the alternate embodiment. The apparatus of this embodiment requires neither the right angle drive, 59, nor the transfer drive, 60, disclosed earlier in this specification. The four bar linkage of the alt torque modulator, 56, in the alternate embodiment is redesigned with unique link lengths and a serial assembly of links with vertical rotation axes as seen in FIG. 2E. The alternate embodiment requires a non standard pivot side stile. The unique pivot side stile, 35, of the alternate embodiment can be used in conjunction with numerous types of door panels. It is particularly beneficial for the all glass door panel, 57, which can be readily attached to the stile by means known to those skilled in the art. Hinged doors as well as pivot hung doors, especially those with offset pivots, present a safety hazard since the gap between the pivot side door edge and the vertical, pivot side door jamb increases as the door opens. A finger, trapped in this gap would be injured as the door returns to its nominal position. The unique cross section profiles of the vertical stile of this invention and that of the door jamb are seen in a top plan view in FIG. 2D. The close proximity and the concentric disposition of the relative concave and convex sections provide a unique and attractive safety enhancement. FIG. 2E, a perspective view, illustrates the gap, 14, the unique stile, 35 and the unique jamb, 47 of this invention. The gap, 14, does not open as the door is displaced. The gap can be as little as ⅛″ and still allow for weather-stripping between the stile and the jamb to seal the building from the exterior environment.

Referring to FIG. 2E, the moving links, 42, 43, and 44 of four bar linkage, 37, are stacked vertically and connected at one crank end, 42, to the door stile, 35, by means of bracket, 41, and at the follower end, 44, coupled to the moving end of the torsion bar, 45, by means of coupling, 46, which prevents relative rotation between the follower, 44, and the torsion bar, 1. Chaises, 38, fixedly mounted to the top door jamb or alternately to the header, 10, provides the bearing supports for four bar linkage, 37. Shaft, 39, fixedly attached to both of bracket, 41, and crank, 42, rotates in chaises bearing, 40. Bracket, 41, is fixedly attached to door stile, 35 with suitable fasteners. Coupler, 43, is pivotably constrained to both of crank, 42, and follower, 44. Torsion bar, 45, is fixedly attached to follower, 44, by way of coupling, 46. The door is shown in the nominal position in FIG. 2A. As the door is displaced from this position, the moving wing of the door rotates into the page of FIG. 2A. As the door begins its motion from the nominal position, the four bar linkage, 37, imposes relatively larger angular rotation on the moving end of the torsion bar, 45. As the door continues to move toward the fully displaced position, the angular rotation imposed upon the moving end of the torsion bar becomes relatively smaller. The reduction in the imposed rotation of the torsion bar is not a linear decrease as the door is displaced, but rather a steep decrease at the beginning of the cycle and a very small decrease at the end of the opening cycle.

### CONCLUSION

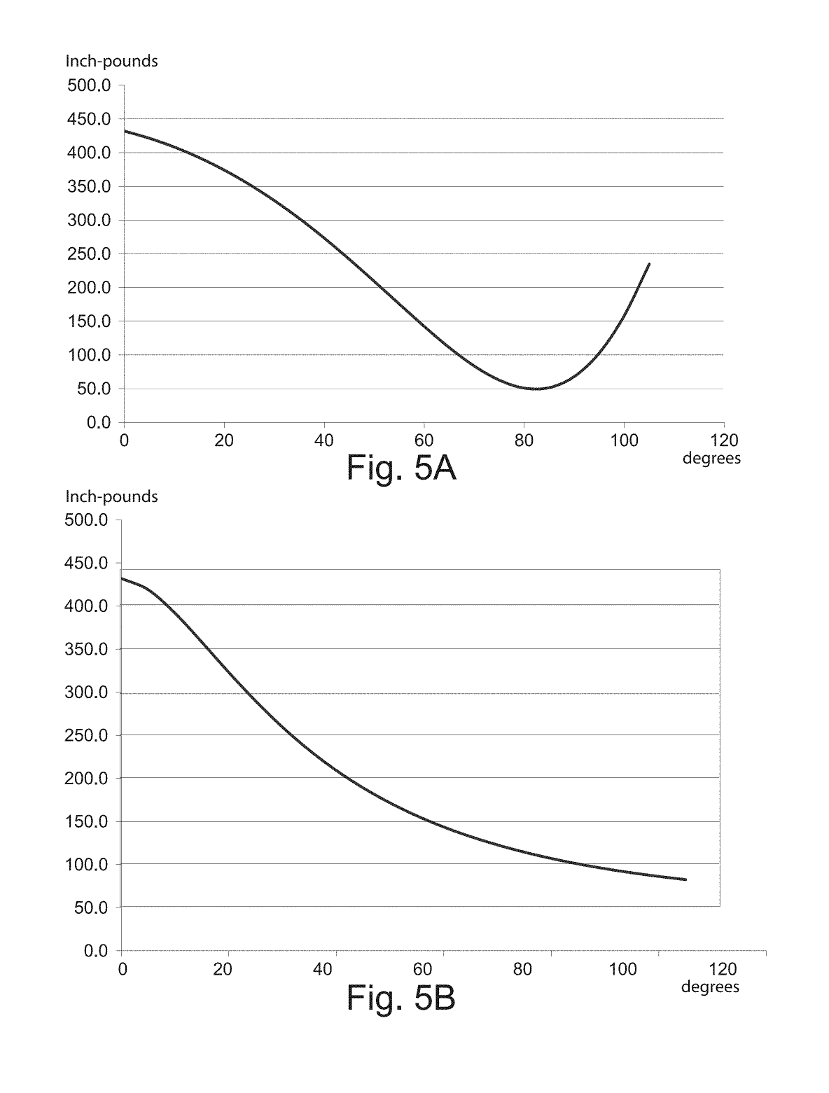

The invention herein consists of a new and novel concealed control system disposed in a pivot hung door, connected to the door surround only at the pivots; including a torsion bar, a means to modulate the torsion bar torque, a rotary dampening means, and an adjustable bottom pivot for ease of commissioning of the door. The main and alternate embodiments of this invention illustrate how the ubiquitous rack and pinion door closers of the existing art can, to advantage, be replaced with an efficient system that stores energy in a torsion bar disposed within a hollow chamber of a pivot hung door and comprising serially disposed elements that are pivotably engaged to one another. The versatility of the control system of this invention is illustrated in FIGS. 5A and 5B. The curves depicted in the graphs represent practical solutions for commercial doors. FIG. 5A shows the non-linear drop in torque on the door as the door is displaced from its nominal position, indicated as zero on the horizontal axis of the graph. The vertical axis is given in units of inch-pounds. The minimum torque on the door is achieved at about 80 degrees of displacement, after which the torque increases. This increase at 80 degrees of displacement is desirable for exterior doors in windy environments to resist wind forces while at the same time still providing a very desirable torque during the manual opening, which is typically less than 90 degrees of opening. The result shown in FIG. 5A is that of the main embodiment of this invention, however, the same result can be achieved by the alternate embodiment. For purposes of illustration FIG. 5B depicts a second torque profile that would be suitable for interior doors. The result shown in FIG. 5B is that of the alternate embodiment of this invention, however, the same result can be achieved by the main embodiment. Those skilled in the art will recognize that an almost limitless variety of torque vs displacement curves can be achieved by well known methods of kinematic linkage synthesis. The advantages of the control system of this invention include:

the entirely concealed hardware provides added safety;

the entirely concealed hardware is secure and tamper proof;

the design is aesthetic and architecturally innovative;

the simplified design efficiently converts the potential energy stored in the torsion bar into the useful work of self closing the door; and the installation in both new construction and retrofit applications is straightforward and easily accomplished by those skilled in the art.

What is claimed is:

1. A self restoring pivot hung door, comprising:
a pivot hung door,
said door having at least one chamber,
a door surround consisting of door jambs, flooring beneath the door and optional header above the door,
a pivot means operatively disposed to allow rotational displacement of said pivot hung door with respect to said door surround,
a torsion means, operatively disposed within said chamber, storing energy during one of, the opening and closing cycles of said pivot hung door, and controllably releasing stored energy during the other cycle of motion of said pivot hung door.
a dampening means, operatively disposed within said chamber, selectively removing kinetic energy of said door during one of, the opening or closing cycles of said door,
whereby said pivot hung door connects to, or contacts, said door surround only at said pivot means.

2. The self restoring pivot hung door of claim 1, whereby said torsion means, and said dampening means are serially disposed and operatively connected for non-rotational relative displacement.

3. The self restoring pivot hung door of claim 1, whereby said torsion means, and said dampening means are serially disposed and operatively connected for non-rotational relative displacement, and whereby said pivot means includes a bottom pivot and a locking torsion plate coupled in relative non rotation with one of said torsion means or said dampening means.

4. The method of setting the magnitude of the torque on said pivot hung door in its nominal position by means of:
locking one of said dampener means or torsion means, to said torsion plate by means of locking sleeve;
manually rotating said pivot hung door to a prescribed opening angle or to a prescribed resistive torque;
locking said torsion means to said pivot hung door;
releasing the lock between said torsion means, or said dampener means, and said torsion plate;
returning said pivot hung door to its resting position;
locking one of said torsion means or said dampener means to said fixed torsion plate.

5. The pivot hung door of claim 1 wherein:
said torsion means comprising at least two of the following:
a torque modulator comprising:
a crank, pivotably connected to said pivot hung door;
a follower link, pivotably connected at distal end to said pivot hung door;
a coupler link, connected at proximal end to said crank for relative rotation thereto and connected at distal end to said follower link for relative rotation thereto;
a right angle drive device comprising:
a first cam pulley fixedly attached to said door frame;
a second cam pulley coupled to said pivot hung door for relative rotation thereto and fixedly coupled to said crank;
said second cam pulley being oriented perpendicular to said cam pulley;
a non endless cable, fixedly attached to said cam pulley and said second cam pulley;
a transfer drive device comprising:
a third cam pulley fixedly coupled to said follower link and coupled to said pivot hung door for relative rotation thereto;
a fourth cam pulley being concentric with said cam pulley;
a second non endless cable being fixedly attached at one end with said third cam pulley and fixedly attached at the other end to said fourth cam pulley;
a torsion bar comprising:
an elongated member having two ends each shaped for non rotational engagement and storing or releasing elastic strain energy as said door oscillates between nominal and a displaced positions;
said elongated member having one end fixed and concentric with said pivot hung door axis of rotation and;
a rotary dampener, being disposed concentric with the pivot axis of said pivot hung door, comprising a housing, a pivotably engagable rotor, upper and lower bearings and seals:
said housing including:
a bore;
fluid flow passage ways;
an elongated boss that extends radially inward from said housing bore;
said rotor including an elongated mid-section extending radially outward to said bore of housing and including shaft extensions on both ends;
said shaft extensions receiving bearings and seals and being shaped for non-rotational engagement to one of said torsion bar ends;
said rotor including a check valve disposed in said mid section;
said rotor being concentrically disposed with respect to said housing bore and operatively disposed to pivot with respect to said housing;
whereby said comprised devices are serially disposed within said chamber in said pivot hung door, and immediately adjacent said comprised devices are coupled to one another to prohibit relative rotation.

6. An adjustable bottom pivot for a pivot hung door
comprising,
a locking torque plate;
a thrust bearing;
a roller bearing;
a rotational lock sleeve;
a locking screw

7. The pivot hung door of claim 5 including:
a convex circular profile on said pivot hung door stile, concentric with a concave circular profile on the vertical pivot side door jamb defining a small gap between the two profiles;
whereby said gap maintains a constant, small separation between said door stile profile and said door jamb profile as the door oscillates between its nominal position and its fully displaced position.
